(19) United States
(12) Patent Application Publication
(10) Pub. No.: US 2012/0042081 A1
(43) Pub. Date: Feb. 16, 2012

(54) COMMUNICATION SYSTEM AND METHOD FOR USING A MULTI-TIERED REGISTRATION SESSION INITIATION PROTOCOL

(75) Inventors: Ching-Fu LIAO, Taipei (TW); Yu-Jheng LIN, Taipei (TW)

(73) Assignee: Chunghwa Telecom Co., Ltd., Taipei (TW)

(21) Appl. No.: 13/018,304

(22) Filed: Jan. 31, 2011

(30) Foreign Application Priority Data
Aug. 13, 2010 (TW) 099127065

(51) Int. Cl. G06F 15/16

(52) U.S. Cl. 709/227

(57) ABSTRACT

A communication system for using a multi-tiered registration session initiation protocol (SIP) includes: a client, a relay server and a plurality of SIP servers. The relay server is connected with the SIP servers and the client. The relay server is configured to establish a connection with the client and register with each of the SIP servers so as to select at least one of the SIP servers for direct communication with the client, thereby solving the conventional problem of incompatibilities existing between the client and SIP servers and between the SIP servers and further saving communication costs for the client in dialing various numbers.

### BACKGROUND OF THE INVENTION

1. Field of the Invention

The present invention relates generally to communication systems and methods for using the session initiation protocol (SIP), and, more particularly, to a communication system and method for using a multi-tiered registration SIP.

2. Description of Related Art

Conventionally, voice communications are accomplished via the public switched telephone network (PSTN) provided by telecom companies. The PSTN is a network used for voice communications worldwide and has several hundred millions of users. Along with the development of the Internet, voice communications are also implemented over the Internet by using protocols such as the voice over Internet protocol (VoIP). The VoIP converts analog voice signals from a sending end into digital signals and then transmits the digital signals to a receiving end that further converts the digital signals back into analog voice signals, thereby achieving voice communication over the Internet. Therein, the session initiation protocol (SIP) is one of the most commonly used communication protocols. In addition, an IP PBX supports direct communication of digital signals over the Internet.

Along with the development of communication technologies, wireless communication technologies such as GSM (global system for mobile communication) mobile phone networks and 3G mobile phone networks are also well developed. In the conventional SIP communication method, a SIP user transmits a communication request to a SIP server of a telecom company and the SIP server transfers the communication request to various phone networks such as PSTN or VoIP according to the dialed number of the communication request, thereby establishing a communication connection.

However, in an environment having a plurality of SIP servers, since the SIP servers usually belong to different telecom companies, it results in a poor compatibility between the SIP servers. As such, a SIP trunk cannot be set up between the SIP servers, thereby preventing communication between the SIP servers. In addition, some clients have low compatibility with SIP servers provided by telecom companies. Therefore, the clients cannot register with the SIP servers or the SIP servers cannot set up SIP trunks to the clients, thereby preventing communication between the clients and the SIP servers. Furthermore, there exist some problems for clients in a network address translation (NAT) environment. For example, when a client registers with a SIP server, since the NAT server translates a virtual network address in an enterprise into a real network address, the SIP server cannot transmit a registration result to the original client, thus adversely affecting registration of the client and resulting in a communication error. In addition, the conventional SIP method lacks a communication cost saving mechanism for the client in dialing various numbers.

Therefore, in a conventional communication system, due to the poor compatibility between a client and SIP servers or a limited NAT environment, the client cannot register with the SIP servers. Further, incompatibility exists between SIP servers. In addition, the conventional communication system lacks a communication cost saving mechanism for the client in dialing various numbers. Therefore, it is imperative to provide a communication method and system so as to overcome the above-described drawbacks.

### SUMMARY OF THE INVENTION

Accordingly, the present invention provides a communication system and method for using multi-tiered registration SIP so as to overcome the conventional drawback of incompatibilities existing between a client and SIP servers and between the SIP servers and to save communication costs for the client in dialing various numbers.

According to an aspect of the present invention, a communication method for using multi-tiered registration SIP comprises the steps of: establishing a connection between a relay server and a client; the relay server registering with a plurality of SIP servers; having the client use SIP to transmit a communication request to the relay server; enabling the relay server to select at least one of the SIP servers so as to transmit the communication request to the selected SIP server; and after checking SIP packet, enabling the selected SIP server to determine whether to permit the communication request and transmit the determination result through the relay server to the client.

The present invention further provides a communication system for using multi-tiered registration SIP, which comprises: a relay server built on the Internet and connected with a client through the Internet; and a plurality of SIP servers built on the Internet and connected with the relay server, wherein the relay server is configured to establish a connection with the client, the relay server is configured to register with the SIP servers, the client is configured to use SIP to transmit a communication request to the relay server, the relay server selects at least one of the SIP servers so as to transmit the communication request to the selected SIP server, and the selected SIP server is configured to check SIP packet so as to determine whether to permit the communication request and transmit the determination result through the relay server to the client.

Compared with the prior art, the present invention uses a relay server to establish a connection with a client and further enables the relay server to register with a plurality of SIP servers so as to select at least one of the SIP servers for direct communication with the client, thereby overcoming the conventional drawback of incompatibilities existing between the client and SIP servers and between the SIP servers and saving communication costs for the client in dialing various numbers.

### BRIEF DESCRIPTION OF DRAWINGS

FIG. 1 is a block diagram showing the structure of a communication system for using multi-tiered registration SIP according to a first embodiment of the present invention;

FIG. 2 is a flow diagram showing a communication method for using multi-tiered registration SIP according to the first embodiment of the present invention;

FIG. 3 is a block diagram showing the structure of a communication system for using multi-tiered registration SIP according to a second embodiment of the present invention;

FIG. 4 is a flow diagram showing a communication method for using multi-tiered registration SIP according to the second embodiment of the present invention;

FIG. 5 is a block diagram showing the structure of a communication system for using multi-tiered registration SIP according to a third embodiment of the present invention; and

FIG. 6 is a flow diagram showing a communication method for using multi-tiered registration SIP according to the third embodiment of the present invention.

### DETAILED DESCRIPTION OF PREFERRED EMBODIMENTS

The following illustrative embodiments are provided to illustrate the disclosure of the present invention and its advantages, these and other advantages and effects will be readily apparent to those in the art after reading this specification.

### First Embodiment

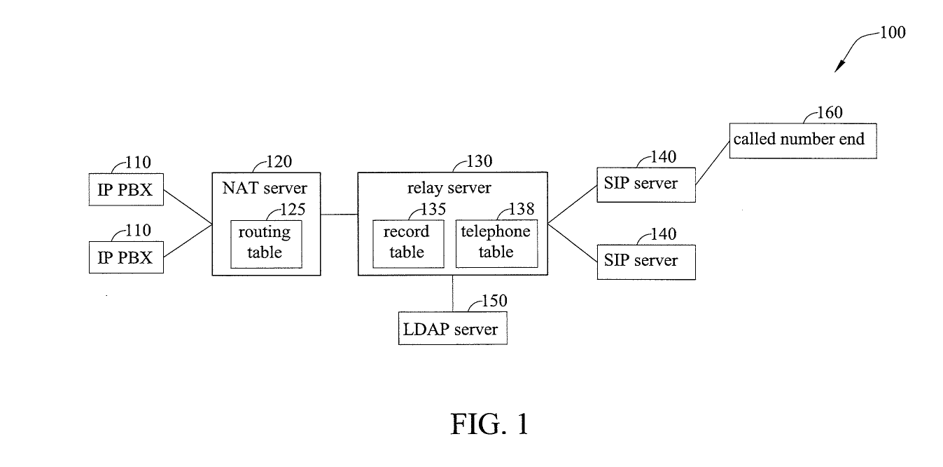

FIG. 1 shows the structure of a communication system 100 for using multi-tiered registration SIP according to a first embodiment of the present invention.

Referring to FIG. 1, the communication system 100 is built on the Internet and composed of an IP PBX 110, a NAT server 120, a relay server 130 and a plurality of SIP servers 140. Therein, the SIP servers 140 are, but are not limited to, multimedia communication servers. The relay server 130 has a record table 135 for recording communication data, such as communication times, between the SIP servers 140 and the IP PBX 110. The relay server 130 further has a telephone table 138 for recording corresponding relationships between the SIP servers 140 and dialing numbers of the IP PBX 110. The NAT server 120 has a routing table 125 for recording the address and port before translation by the NAT server and the address and port after translation by the NAT server. The present embodiment shows two IP PBXs, but it is not limited thereto.

In the communication system 100, the IP PBX 110 is connected with the NAT server 120 such that the NAT server 120 translates input virtual addresses and ports into real addresses and ports and stores the virtual and real addresses and ports in the routing table 125. The relay server 130 is connected with the IP PBX 110 through the NAT server 120. The SIP servers 140 are connected with the relay server 130.

The communication system 100 can further selectively comprise a lightweight directory access protocol (LDAP) server 150, which is connected with the relay server 130 for managing accounts and passwords.

The communication system 100 further has a called number end 160, which is connected with one of the SIP servers 140 for transmission of communication packets. In the present embodiment, the connection relationship between the called number end 160 and the SIP servers 140 is only illustrative. In other embodiments, the called number end 160 can be connected with other SIP servers 140.

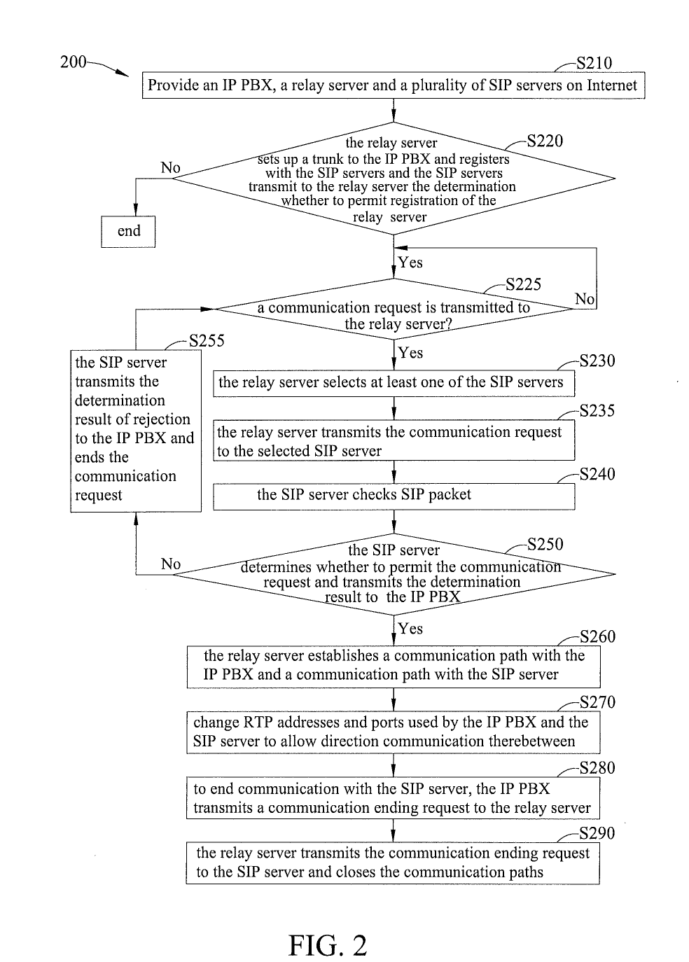

FIG. 2 shows the flow process of a communication method 200 for using multi-tiered registration SIP according to the first embodiment of the present invention.

Referring to FIG. 2, at step S210, an IP PBX 110, a relay server 130 and a plurality of SIP servers 140 are provided on the Internet, wherein the relay server 130 is connected with the SIP servers 140 and further connected with the IP PBX 110 through the NAT server 120. Then, the process goes to step S220.

At step S220, the relay server 130 sets up a trunk to the IP PBX 110 and registers with the SIP servers 140, wherein the SIP servers 140 check the account and/or password so as to determine whether to permit registration of the relay server 130 and transmit the determination result to the relay server 130. If the relay server 130 is permitted to register, a positive determination result granting permission is transmitted to the relay server 130 and the process goes to step S225, otherwise, a negative determination result indicating rejection is transmitted to the relay server 130 and the process is ended.

At step S225, the relay server 130 listens to determine whether a communication request is transmitted to the relay server 130, wherein, if it is, the process goes to step S230, and, otherwise, control returns to the beginning of step S225.

At step S230, when the IP PBX 110 uses SIP to transmit a communication request through the NAT server 120 to the relay server 130, the relay server 130 selects at least one of the SIP servers 140 according to the telephone table 138. Preferably, the relay server 130 selects at least one of the SIP servers 140 according to the corresponding relationship between the SIP servers 140 and the dialing numbers of the IP PBX 110 in the telephone table 138. Further, the relay server 130 changes the content of the SIP packet, Preferably, the header source of the SIP packet is changed from the address and port of the client before translation by the NAT server 120 to the address and port of the relay server 130. Then, the process goes to step S235.

At step S235, the relay server 130 transmits the communication request to the selected SIP server 140. Then, the process goes to step S240.

At step S240, the selected SIP server 140 checks the SIP packet, which involves checking the address and port, account, SIP domain, called number and/or maximum number of calls permitted at the same time. Then, the process goes to step S250.

At step S250, according to the checking result, the selected SIP server 140 determines whether to permit the communication request, and, after verifying that the communication condition of the called number end 160 is normal, the selected SIP server 140 transmits the determination result through the relay server 130 to the IP PBX 110. Therein, when the selected SIP server 140 uses SIP to transmit the determination result through the relay server 130 to the IP PBX 110, the relay server 130 changes the content of the SIP packet. Preferably, the header source of the SIP packet is changed from the address and port of the selected SIP server 140 to the address and port before translation by the NAT server 120. If the communication request is permitted, the process goes to step S260, otherwise, the process goes to step S255.

At step S255, the selected SIP server 140 transmits the negative determination result indicating rejection to the IP PBX 110 through the relay server 130 and ends the communication request. Then, the process goes to step S225. In other embodiments, after the communication request is ended, the process can be selectively ended. At step S260, the selected SIP server 140 transmits the positive determination result granting permission to the IP PBX 110 through the relay server 130, and the relay server 130 establishes a communication path with the IP PBX 110 and chooses to use an account corresponding to the selected SIP server 140 so as to establish a communication path with the selected SIP server 140, thereby allowing communication packets to be transmitted to the called number end 160 connected to the selected SIP server 140. The relay server 130 records communication data such as the time of establishing of the communication path so as to authenticate and manage the IP PBX 110. Then, the process goes to step S270.

At step S270, when the IP PBX 110 transmits a communication packet to the relay server 130, the relay server 130 records the real-time transfer protocol (RTP) address and port used by the IP PBX 110. Further, the relay server 130 sends a re-invite request to the IP PBX 110 and changes the RTP address and port used by the IP PBX 110 so as to allow direct communication between the IP PBX 110 and the selected SIP server 140. When the selected SIP server 140 transmits a communication packet to the relay server 130, the relay server 130 records the RTP address and port used by the selected SIP server 140. Further, the relay server 130 sends a re-invite request to the selected SIP server 140 and changes the RTP address and port used by the selected SIP server 140 so as to allow direct communication between the IP PBX 110 and the selected SIP server 140. Then, the process goes to step S280.

At step S280, in order to end communication with the selected SIP server 140, the IP PBX 110 transmits a communication-ending request to the relay server 130 and the relay server 130 records communication data such as the time of closing of the communication path so as to authenticate and manage the IP PBX 110. Then, the process goes to step S290.

At step S290, the relay server 130 transmits the communication-ending request to the selected SIP server 140 and closes the communication paths and processes the communication data related to the establishing and closing of the communication paths so as to authenticate and manage the IP PBX 110. For example, based on the time of establishing of a communication path and the time of closing the communication path, the relay server 130 can calculate communication expenses, but it is not limited thereto.

### Second Embodiment

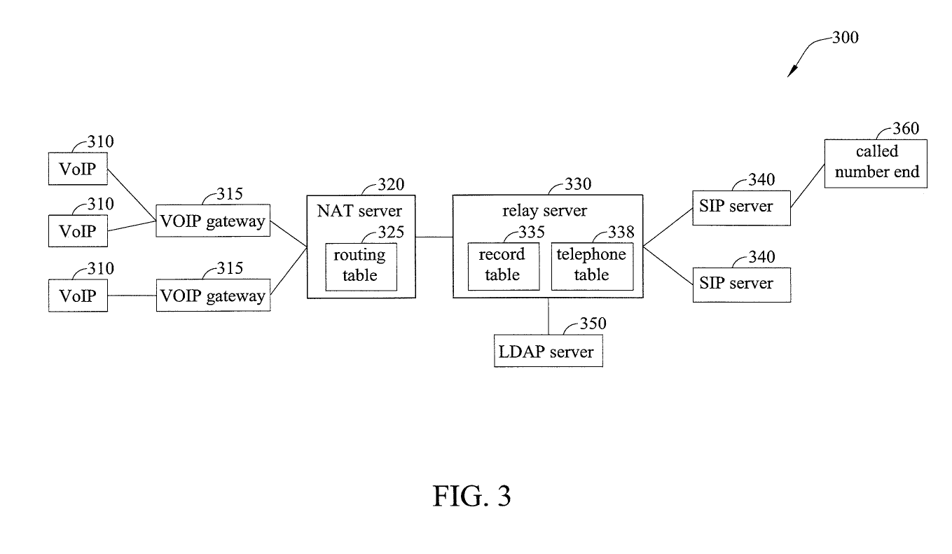

FIG. 3 shows the structure of a communication system 300 for using multi-tiered registration SIP according to a second embodiment of the present invention. The main difference of the present embodiment from the first embodiment is that the present embodiment uses a VoIP device and a VoIP gateway instead of the IP PBX of the first embodiment. Since the application environment and steps of the present embodiment are the same as those of the first embodiment, detailed description thereof is omitted herein.

Referring to FIG. 3, the communication system 300 is built on the Internet and comprises: a VoIP device 310, a VoIP gateway 315, a NAT server 320, a relay server 330 and a plurality of SIP servers 340. Therein, the VoIP device 310 is connected with the VoIP gateway 315, and the VoIP gateway 315 is connected with the NAT server 320. The NAT server 320 translates input virtual addresses and ports into real addresses and ports and stores the virtual and real addresses and ports in a routing table 325. The relay server 330 is connected with the VoIP gateway 315 through the NAT server 320, and the relay server 330 has a record table 335 and a telephone table 338. The SIP servers 340 are connected with the relay server 330. It should be noted that the number of VoIP devices, VoIP gateways and SIP servers shown in the drawing are only for illustrative purposes and not intended to limit the present invention.

The communication system 300 can further selectively comprise an LDAP server 350, which is connected with the relay server 330 for managing accounts and passwords.

The communication system 300 can further selectively comprise a called number end 360, which is connected with one of the SIP servers 340 for transmission of communication packets. It should be noted that the connection relationship between the called number end 360 and the SIP servers 340 of the present embodiment is only illustrative. In other embodiments, the called number end 360 can be connected with other SIP servers 340.

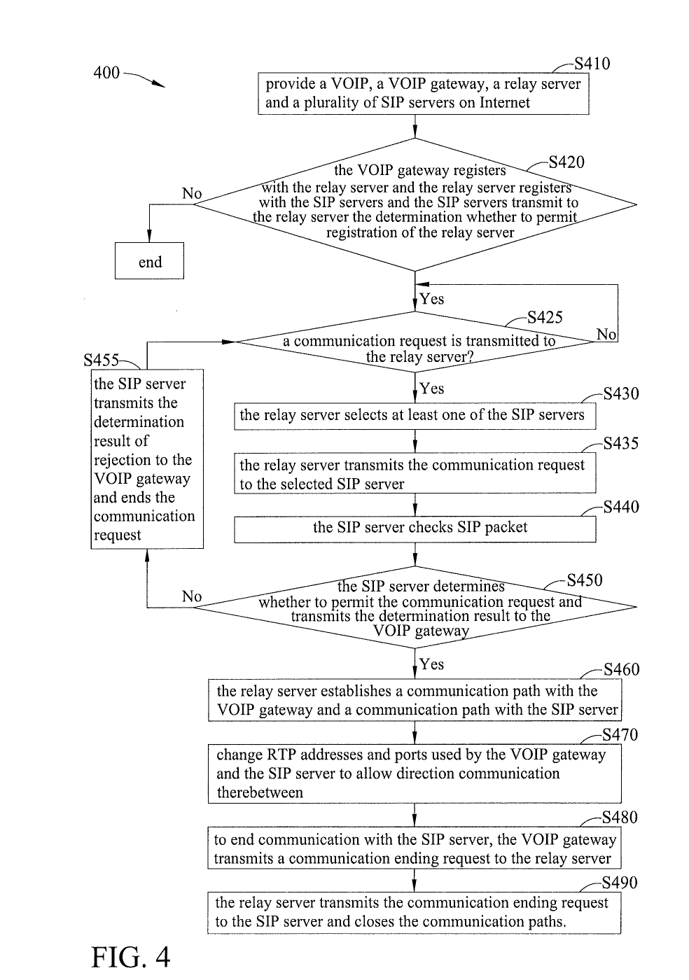

FIG. 4 shows the flow process of a communication method 400 for using multi-tiered registration SIP according to the second embodiment of the present invention.

Referring to FIG. 4, at step S410, a VoIP device 310, a VoIP gateway 315, a relay server 330 and a plurality of SIP servers 340 are provided on the Internet. Therein, the VoIP device 310 is connected with the VoIP gateway 315, the relay server 330 is connected with the SIP servers 340 and further connected with the VoIP gateway 315 through the NAT server 320. Then, the process goes to step S420.

At step S420, the VoIP gateway 315 registers with the relay server 330 and the relay server 330 registers with the SIP servers 340, wherein the SIP servers 340 check accounts and/or passwords so as to determine whether to permit registration of the relay server 330 and transmit the determination result to the relay server 330. If the relay server 330 is permitted to register, a positive determination result granting permission is transmitted to the relay server 330 and the process goes to step S425, otherwise, a negative determination result indicating rejection is transmitted to the relay server 330 and the process is ended.

At step S425, the relay server 330 listens to determine whether a communication request is transmitted to the relay server 330, wherein, if one is, the process goes to step S430, and, otherwise, control returns to the beginning of step S425.

At step S430, when the VoIP gateway 315 uses SIP to transmit a communication request through the NAT server 320 to the relay server 330, the relay server 330 selects at least one of the SIP servers 340 according to the telephone table 338. Preferably, the relay server 330 selects at least one of the SIP servers 340 according to the corresponding relationship between the SIP servers 340 and dialing numbers of the VoIP gateway 315 in the telephone table 338. Further, the relay server 330 changes the content of the SIP packet. Preferably, the header source of the SIP packet is changed from the address and port of the client before translation by the NAT server 320 to the address and port of the relay server 330. Then, the process goes to step S435.

At step S435, the relay server 330 transmits the communication request to the selected SIP server 340. Then, the process goes to step S440.

At step S440, the selected SIP server 340 checks the SIP packet, which involves checking the address and port, account, SIP domain, called number and/or maximum number of calls at the same time. Then, the process goes to step S450.

At step S450, according to the checking result, the selected SIP server 340 determines whether to permit the communication request, and, after verifying that the communication condition of the called number end 360 is normal, the selected SIP server 340 transmits the determination result through the relay server 330 to the VoIP gateway 315. Therein, when the selected SIP server 340 uses SIP to transmit the determination result through the relay server 330 to the VoIP gateway 315, the relay server 330 changes the content of SIP packet. Preferably, the header source of the SIP packet is changed from the address and port of the selected SIP server 340 to the address and port before translation by the NAT server 320. If the communication request is permitted, the process goes to step S460, otherwise, the process goes to step S455.

At step S455, the selected SIP server 340 transmits the negative determination result indicating rejection to the VoIP gateway 315 through the relay server 330 and ends the communication request. Then, the process goes to step S425. In other embodiments, after the communication request is ended, the process can be selectively ended.

At step S460, the selected SIP server 340 transmits the positive determination result granting permission to the VoIP gateway 315 through the relay server 330, and the relay server 330 establishes a communication path with the VoIP gateway 315 and chooses to use an account corresponding to the selected SIP server 340 so as to establish a communication path with the selected SIP server 340, thereby allowing communication packets to be transmitted to the called number end 360 connected with the selected SIP server 340. The relay server 330 records communication data such as the time of establishing of the communication paths so as to authenticate and manage the VoIP gateway 315. Then, the process goes to step S470.

At step S470, when the VoIP gateway 315 transmits a communication packet to the relay server 330, the relay server 330 records the RTP address and port used by the VoIP gateway 315. Further, the relay server 330 sends a re-invite request to the VoIP gateway 315 and changes the RTP address and port used by the VoIP gateway 315 so as to allow direct communication between the VoIP gateway 315 and the SIP server 340. When the SIP server 340 transmits a communication packet to the relay server 330, the relay server 330 records the RTP address and port used by the selected SIP server 340. Further, the relay server 330 sends a re-invite request to the selected SIP server 340 and changes the RTP address and port used by the selected SIP server 340 so as to allow direct communication between the VoIP gateway 315 and the selected SIP server 340. Then, the process goes to step S480.

At step S480, in order to end communication with the selected SIP server 340, the VoIP gateway 315 transmits a communication-ending request to the relay server 330 and the relay server 330 records communication data such as the time of closing of the communication paths so as to authenticate and manage the VoIP gateway 315. Then, the process goes to step S490.

At step S490, the relay server 330 transmits the communication-ending request to the selected SIP server 340 and closes the communication paths and processes the communication data related to the establishing and closing of the communication paths so as to authenticate and manage the VoIP gateway 315. For example, based on the time of establishing of the communication paths and the time of closing the communication paths, the relay server 330 can calculate communication expenses, but it is not limited thereto.

In the above-described embodiment, the IP PBX and the VoIP gateway can be referred to as clients, and the relay server setting up a trunk to the IP PBX and the VoIP gateway registering with the relay server can be referred to as establishing connection between the relay server and the clients.

### Third Embodiment

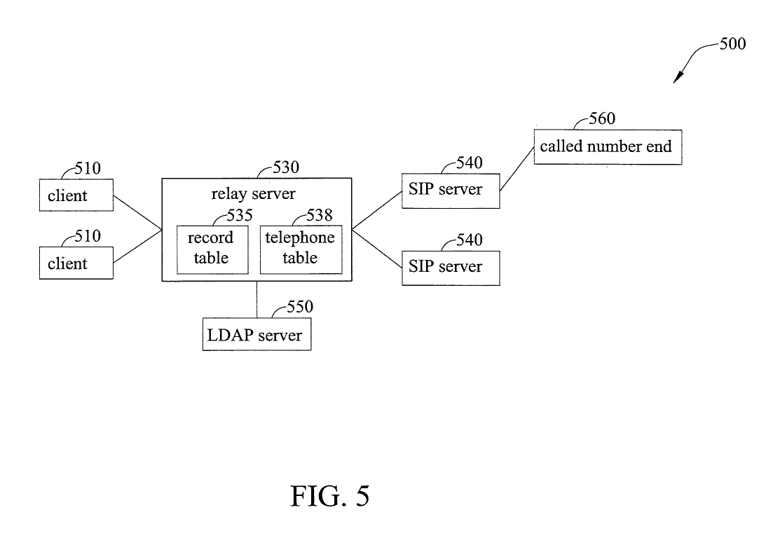

FIG. 5 shows the structure of a communication system 500 for using multi-tiered registration SIP according to a third embodiment of the present invention. The main difference of the present embodiment from the first and second embodiments is that the NAT server and the routing table are eliminated in the present embodiment. Since the application environment and steps of the present embodiment are the same as those of the first and second embodiments, detailed description thereof is omitted herein.

Referring to FIG. 5, the communication system 500 is built on the Internet and comprises a relay server 530 and a plurality of SIP servers 540. Therein, the relay server 530 is connected with a client 510, and the relay server 330 has a record table 535 and a telephone table 538. The SIP servers 540 are connected with the relay server 530. It should be noted that the number of clients 510 and SIP servers 540 shown in the drawing are only for illustrative purposes and not intended to limit the present invention.

The communication system 500 can further selectively comprise an LDAP server 550, which is connected with the relay server 530 for managing accounts and passwords.

The communication system 500 can further selectively comprise a called number end 560, which is connected with one of the SIP servers 540 for transmission of communication packets. It should be noted that the connection relationship between the called number end 560 and the SIP servers 540 of the present embodiment is only illustrative, In other embodiments, the called number end 560 can be connected with other SIP servers 540.

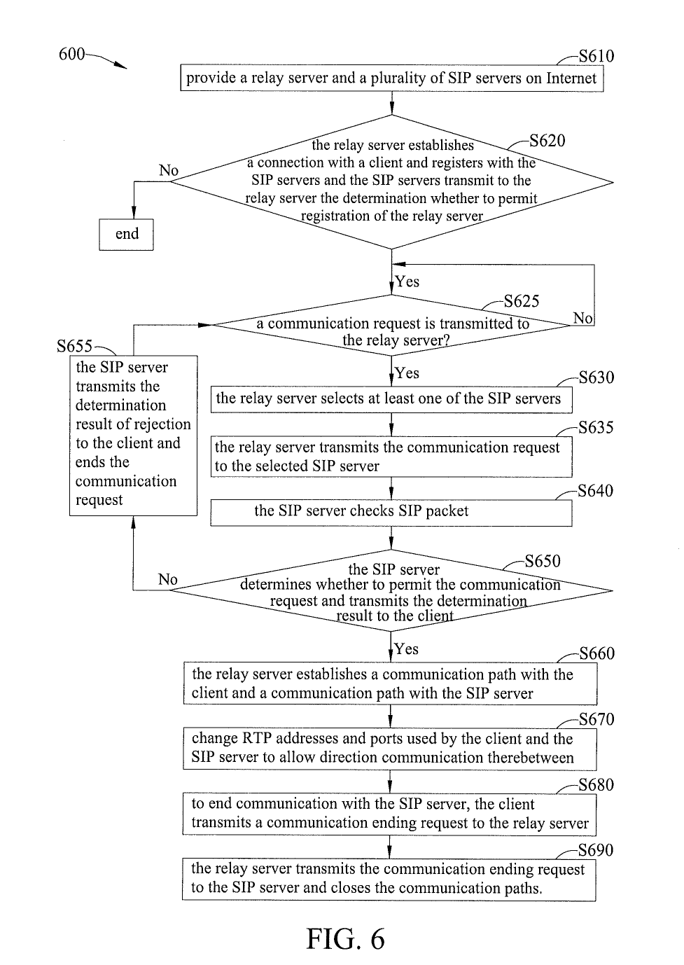

FIG. 6 shows the flow process of a communication method 600 for using multi-tiered registration SIP according to the third embodiment of the present invention.

Referring to FIG. 6, at step S610, a relay server 530 and a plurality of SIP servers 540 are provided on the Internet. Therein, the relay server 530 is connected with a client 510 and the SIP servers 340. Then, the process goes to step S620.

At step S620, the relay server 530 establishes a connection with the client 510 and registers with the SIP servers 540, wherein the SIP servers 540 check the account and/or password so as to determine whether to permit registration of the relay server 530 and transmit the determination result to the relay server 530. If the relay server 530 is permitted to register, a positive determination result granting permission is transmitted to the relay server 530 and the process goes to step S625, otherwise, a negative determination result indicating rejection is transmitted to the relay server 530 and the process is ended.

At step S625, the relay server 530 listens to determine whether a communication request is transmitted to the relay server 530, wherein, if yes, the process goes to step S630, and, otherwise, control returns to the beginning of step S625.

At step S630, when the client 510 uses SIP to transmit a communication request to the relay server 530, the relay server 530 selects at least one of the SIP servers 540 according to the telephone table 538. Preferably, the relay server 530 selects at least one of the SIP servers 540 according to the corresponding relationship between the SIP servers 540 and dialing numbers of the client 510 in the telephone table 538. Then, the process goes to step S635.

At step S635, the relay server 530 transmits the communication request to the selected SIP server 540. Then, the process goes to step S640.

At step S640, the selected SIP server 540 checks the SIP packet, which involves checking the address and port, account, SIP domain, called number and/or maximum number of calls at the same time. Then, the process goes to step S650.

At step S650, according to the checking result, the selected SIP server 540 determines whether to permit the communication request, and, after verifying that the communication condition of the called number end 560 is normal, the selected SIP server 540 transmits the determination result through the relay server 530 to the client 510. If the communication request is permitted, the process goes to step S660, otherwise, the process goes to step S655.

At step S655, the selected SIP server 540 transmits the negative determination result indicating rejection to the client 510 through the relay server 530 and ends the communication request. Then, the process goes to step S625. In other embodiments, after the communication request is ended, the process can be selectively ended.

At step S660, the selected SIP server 540 transmits the positive determination result granting permission to the client 510 through the relay server 530, and the relay server 530 establishes a communication path with the client 510 and chooses to use an account corresponding to the selected SIP server 540 so as to establish a communication path with the selected SIP server 540, thereby allowing communication packets to be transmitted to the called number end 560 connected with the selected SIP server 540. The relay server 530 records communication data such as the time of establishing of the communication paths so as to authenticate and manage the client 510. Then, the process goes to step S670.

At step S670, when the client 510 transmits a communication packet to the relay server 530, the relay server 530 records the RTP address and port used by the client 510. Further, the relay server 530 sends a re-invite request to the client 510 and changes the RTP address and port used by the client 510 so as to allow direct communication between the client 510 and the selected SIP server 540. When the selected SIP server 540 transmits a communication packet to the relay server 530, the relay server 530 records the RTP address and port used by the selected SIP server 540. Further, the relay server 530 sends a re-invite request to the SIP server 540 and changes the RTP address and port used by the selected SIP server 540 so as to allow direct communication between the client 510 and the selected SIP server 540. Then, the process goes to step S680.

At step S680, in order to end communication with the SIP server 540, the client 510 transmits a communication-ending request to the relay server 530 and the relay server 530 records communication data such as the time of closing of the communication paths so as to authenticate and manage the client 510. Then, the process goes to step S690.

At step S690, the relay server 530 transmits the communication-ending request to the selected SIP server 540 and closes the communication paths and processes the communication data related to the establishing and closing of the communication paths so as to authenticate and manage the client 510. For example, based on the time of establishing of the communication paths and the time of closing the communication paths, the relay server 530 can calculate communication expenses, but it is not limited thereto.

Referring again to FIG. 5, if the client 510 wants to dial, for example, telephone number 0212345678 to reach the called number end 560, when the related communication request is transmitted to the relay server 530, the relay server 530 selects at least one of the SIP servers 540 with lower communication expenses according to the corresponding relationship between the SIP servers 540 and the dialing numbers of the client 510 in the telephone table 538. Similarly, if the client 510 wants to dial, for example, mobile phone number 0912345678 to reach the called number end 560, when the related communication request is transmitted to the relay server 530, the relay server 530 selects at least one of the SIP servers 540 with lower communication expenses according to the corresponding relationship between the SIP servers 540 and the dialing numbers of the client 510 in the telephone table 538. Therefore, according to the telephone table of the relay server, the SIP servers with lower communication expenses can be selected corresponding to varied dialing numbers, thereby saving communication costs for the client. Therefore, the present invention uses a relay server to establish connection with a client and further causes the relay server to register with a plurality of SIP servers so as to select at least one of the SIP servers for direction communication with the client, thereby overcoming the conventional drawback of incompatibilities existing between the client and SIP servers and between the SIP servers and saving communication costs for the client in dialing various numbers.

The above-described descriptions of the detailed embodiments are provided to illustrate the preferred implementation according to the present invention, and are not intended to limit the scope of the present invention. Accordingly, many modifications and variations completed by those with ordinary skill in the art can still fall within the scope of the present invention as defined by the appended claims.

1. A communication method for using multi-tiered registration with the session initiation protocol (SIP), comprising the steps of:
establishing a connection between a relay server and a client;
registering the relay server with a plurality of SIP servers;
having the client use SIP to transmit a communication request via a SIP packet to the relay server;
enabling the relay server to select at least one of the SIP servers so as to transmit the communication request to the selected SIP server; and
after checking the SIP packet of the communication request, enabling the selected SIP server to determine whether to permit the communication request and to transmit the determination result through the relay server to the client.

2. The method of claim 1, wherein the client is built on the Internet, the relay server is built on the Internet and connected with the client, and the SIP servers are built on the Internet and connected with the relay server.

3. The method of claim 1, wherein the relay server uses a telephone table for selecting at least one of the SIP servers.

4. The method of claim 3, wherein the relay server selects at least one of the SIP servers according to a corresponding relationship between the SIP servers and dialing numbers of the client in the telephone table.

5. The method of claim 1, wherein the client uses SIP to transmit the communication request to the relay server through a network address translation (NAT) server.

6. The method of claim 5, wherein, when the communication request is transmitted from the client to the relay server through the NAT server by using SIP, the relay server changes the content of the SIP packet.

7. The method of claim 6, wherein the step of changing the content of the SIP packet comprise changing a header source of the SIP packet from an address and a port of the client before translation by the NAT server to those of the relay server.

8. The method of claim 1, further comprising: when the SIP server determines to permit the communication request, enabling the SIP server to transmit a positive determination result through the relay server to the client, and enabling the relay server to establish a communication path with the client and choose to use an account corresponding to the SIP server so as to establish a communication path with the SIP server.

9. The method of claim 8, further comprising:
in order to end communication with the SIP server, enabling the client to transmit a communication-ending request to the relay server;
enabling the relay server to transmit the communication-ending request to the SIP server; and
closing the communication path by the relay server.

10. The method of claim 9, wherein the relay server records communication data related to the establishing and closing of the communication path.

11. The method of claim 10, wherein the communication data is communication time.

12. The method of claim 1, further comprising: when the SIP server determines to reject the communication request, enabling the SIP server to transmit a negative determination result through the relay server to the client and end the communication request.

13. The method of claim 1, wherein, when the relay server registers with the SIP servers, the SIP servers check account and/or password data to determine whether to permit registration of the relay server and transmit a determination result to the relay server.

14. The method of claim 1, wherein the step of checking the SIP packet involves checking address and port, account, SIP domain, called number and/or maximum number of calls at the same time.

15. The method of claim 1, further comprising:
when the client transmits a communication packet to the relay server, enabling the relay server to record real-time transfer protocol (RTP) address and port used by the client; and
enabling the relay server to transmit a re-invite request to the client and change the RTP address and port used by the client so as to allow direct communication between the client and the SIP server.

16. The method of claim 15, further comprising:
when the SIP server transmits the communication packet to the relay server, enabling the relay server to record RTP address and port used by the SIP server; and
enabling the relay server to transmit a re-invite request to the SIP server and change the RTP address and port used by the SIP server so as to allow direct communication between the client and the SIP server.

17. The method of claim 1, wherein the client is one of a VoIP gateway and an IP PBX.

18. The method of claim 17, wherein, if the client is a VoIP gateway, the client registers with the relay server to establish the connection between the client and the relay server.

19. The method of claim 17, wherein, if the client is an IP PBX, the relay server sets up a trunk to the client so as to establish the connection between the client and the relay server.

20. (canceled)

21. A communication system for using multi-tiered registration with SIP, comprising:
a relay server built on the Internet and connected with a client through the Internet; and
a plurality of SIP servers built on the Internet and connected with the relay server,
wherein the relay server is configured to establish connection with the client, the relay server is configured to register with the SIP servers, the client is configured to use SIP to transmit a communication request via a SIP packet to the relay server, the relay server selects at least one of the SIP servers so as to transmit the communication request to the selected SIP server, and the selected SIP server is configured to check the SIP packet so as to determine whether to permit the communication request and transmit the determination result through the relay server to the client.

22-30. (canceled)
